(19) United States
(12) Patent Application Publication
(10) Pub. No.: US 2016/0168979 A1
(43) Pub. Date: Jun. 16, 2016

(54) SYSTEM AND METHOD FOR IDENTIFYING A MODE OF FAILURE IN A PUMP USED IN HYDRAULIC FRACTURING

(71) Applicant: Caterpillar Inc., Peoria, IL (US)

(72) Inventors: Yanchai Zhang, Dunlap, IL (US); Evan Earl Jacobson, Edwards, IL (US); Koti Ratnam Padarthy, Edwards, IL (US); Venkata Bhagavathi Dandibhotla, Peoria, IL (US)

(73) Assignee: Caterpillar Inc., Peoria, IL (US)

(21) Appl. No.: 14/571,727

(22) Filed: Dec. 16, 2014

(51) Int. Cl. E21B 47/06; G01M 10/00; E21B 43/26

(52) U.S. Cl. CPC E21B 47/06; E21B 43/26; G01M 10/00

(57) ABSTRACT

A method for identifying a mode of failure in a pump includes receiving and recording a first set of flow rate pressure values over a specified time period to determine an existing hydraulic signature of the pump. The method then includes receiving and recording real-time flow rate pressure values over a subsequent period of time to determine a current hydraulic signature of the pump. The method further includes comparing the real-time flow rate pressure values to the first set of flow rate pressure values to detect variances in the hydraulic signature and output a mode of failure for the pump.

### TECHNICAL FIELD

The present disclosure relates to a system for identifying a mode of failure. More particularly, the present disclosure relates to a system for identifying a mode of failure in a pump that is used in a hydraulic fracturing or ‘fracking’ operation.

### BACKGROUND

Pumps that are used in hydraulic fracturing or ‘fracking’ operations are configured to pressurize and transfer a fracturing fluid into a downhole wellbore for creating cracks in deep-rock formations located under the earth's surface. Typically, a pump includes several components that may be subject to high working pressures. An overall performance of the pump may depend on the health of the components present in the pump. A smooth working of the pump may be maintained by monitoring a health and performance of the components present in the pump. For reference, U.S. Pat. No. 7,689,368 discloses a system for early detection of component failure in a hydraulic system.

### SUMMARY OF THE DISCLOSURE

In one aspect of the present disclosure, a method for identifying a mode of failure in a pump includes receiving and recording a first set of flow rate pressure values over a specified time period to determine an existing hydraulic signature of the pump. The method then includes receiving and recording real-time flow rate pressure values over a subsequent period of time to determine a current hydraulic signature of the pump. The method further includes comparing the real-time flow rate pressure values to the first set of flow rate pressure values to detect variances in the hydraulic signature and output a mode of failure for the pump.

In another aspect of the present disclosure, a system for identifying a mode of failure in a pump includes at least one pressure sensor associated with at least one of a suction manifold, a discharge manifold, and a cylinder of the pump to output pressure values associated with the at least one of the suction manifold, the discharge manifold, and the cylinder of the pump. The system further includes a historical dataset comprising a first set of flow rate pressure values obtained from the at least one pressure sensor. The first set of flow rate pressure values is obtained over a specified time period to determine an existing hydraulic signature of the pump.

The system further includes a data acquisition engine (DAE) configured to obtain real-time flow rate pressure values from the at least one pressure sensor. The real-time flow rate pressure values are measured during a current operating condition of the pump to determine a current hydraulic signature of the pump. The system further includes a comparison engine in communication with the historical dataset and the DAE. The comparison engine is configured to compare the real-time flow rate pressure values to the first set of flow rate pressure values to detect variances in the hydraulic signatures and output a mode of failure for the pump.

In yet another aspect of the present disclosure, a non-transitory computer-readable medium is provided. The non-transitory computer-readable medium has sequences of instruction stored thereon, the sequences of instruction including instruction which when executed by a computer-based system for identifying a mode of failure in a pump, causes the computer-based system to receive and record a first set of flow rate pressure values over a specified time period to determine an existing hydraulic signature of the pump; receive and record real-time flow rate pressure values over a subsequent period of time to determine a current hydraulic signature of the pump; and compare the real-time flow rate pressure values to the first set of flow rate pressure values to detect variances in the hydraulic signature and output a mode of failure for the pump.

Other features and aspects of this disclosure will be apparent from the following description and the accompanying drawings.

### BRIEF DESCRIPTION OF THE DRAWINGS

FIG. 1 is a diagrammatic illustration of an exemplary pump employing a system for identifying a mode of failure in the pump, in accordance with an embodiment of the present disclosure;

FIG. 2 is a diagrammatic illustration of an exemplary low-level process pursuant to embodiments of the present disclosure;

FIG. 3A is an exemplary plot representative of a mode of failure identified upon comparison of a current hydraulic signature with an existing hydraulic signature of the pump;

FIG. 3B is an exemplary plot representative of a mode of failure identified upon comparison of a current hydraulic signature with an existing hydraulic signature of the pump;

FIG. 3C is an exemplary plot representative of a mode of failure identified upon comparison of a current hydraulic signature with an existing hydraulic signature of the pump;

FIG. 3D is an exemplary plot representative of a mode of failure identified upon comparison of a current hydraulic signature with an existing hydraulic signature of the pump;

FIG. 3E is an exemplary plot representative of a mode of failure identified upon comparison of a current hydraulic signature with an existing hydraulic signature of the pump;

FIG. 3F is an exemplary plot representative of a mode of failure identified upon comparison of a current hydraulic signature with an existing hydraulic signature of the pump;

FIG. 3G is an exemplary plot representative of a mode of failure identified upon comparison of a current hydraulic signature with an existing hydraulic signature of the pump;

FIG. 3H is an exemplary plot representative of a mode of failure identified upon comparison of a current hydraulic signature with an existing hydraulic signature of the pump;

FIG. 3I is an exemplary plot representative of a mode of failure identified upon comparison of a current hydraulic signature with an existing hydraulic signature of the pump;

FIG. 4 is a block diagram of an exemplary computer system, according to an embodiment of the present disclosure; and

FIG. 5 is a flowchart illustrating a method of monitoring performance of a pump, in accordance with an embodiment of the present disclosure.

### DETAILED DESCRIPTION

The detailed description of exemplary embodiments of the disclosure herein makes reference to the accompanying drawings and figures, which show the exemplary embodiments by way of illustration only. While these exemplary embodiments are described in sufficient detail to enable those skilled in the art to practice the disclosure, it should be understood that other embodiments may be realized and that logical and mechanical changes may be made without departing from the spirit and scope of the disclosure. It will be apparent to a person skilled in the pertinent art that this disclosure can also be employed in a variety of other applications. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the user operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present disclosure is described herein with reference to system architecture, block diagrams and flowchart illustrations of methods, and processes according to various aspects of the disclosure. It will be understood that each functional block of the block diagrams, screenshots and the flowchart illustrations, and combinations of functional blocks in the block diagrams, screenshots and flowchart illustrations, respectively, can be implemented by computer program instructions.

These computer program instructions may be loaded onto a general purpose computer, special purpose computer, or other programmable data processing apparatus to produce the disclosed system, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory perform functions consistent with the present disclosure including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The systems, methods and processes disclosed in conjunction with various embodiments of the present disclosure are embodied in systems, modules, and methods for identifying a mode of failure in a pump that is used in a hydraulic fracturing or ‘fracking’ operation. Specific nomenclature used herein is merely exemplary and only used for descriptive purposes. Hence, such nomenclature must not be construed as being limiting of the scope of the present disclosure.

The present disclosure is now described in more detail herein in terms of the disclosed exemplary embodiments of system, processes and methods. This is for convenience only and is not intended to limit the application of the present disclosure. In fact, after reading the following description, it will be apparent to one skilled in the relevant art(s) how to implement the following disclosure in alternative embodiments.

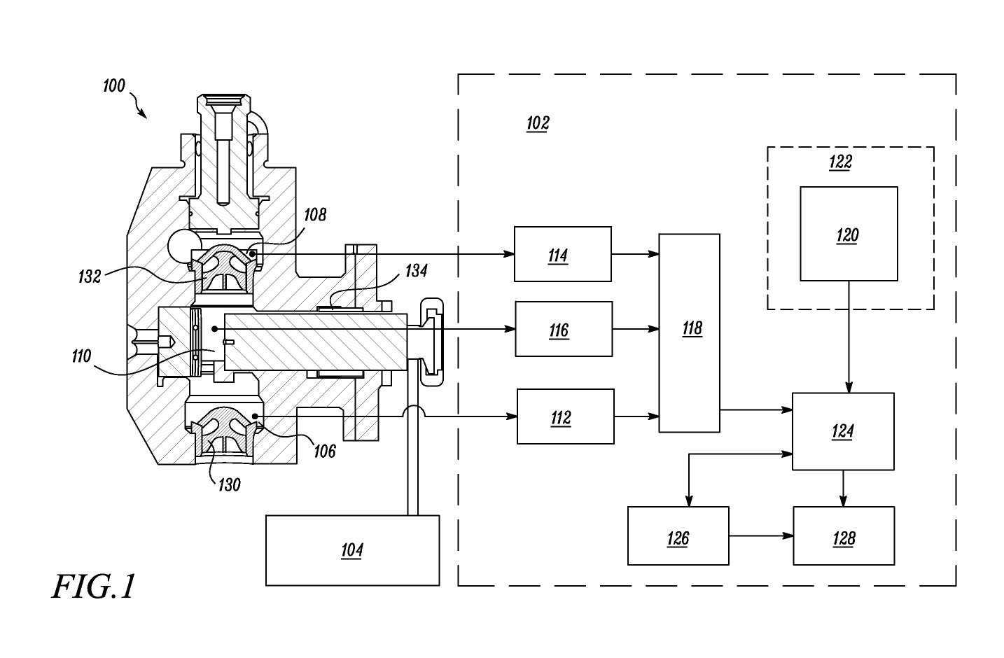

FIG. 1 shows a diagrammatic illustration of an exemplary pump that can be used in a hydraulic fracturing or ‘fracking’ operation, hereinafter referred to as “pump 100”. As shown in accordance with an embodiment of the present disclosure, the pump 100 employs a system 102 for identifying a mode of failure in the pump 100. The pump 100 of the present disclosure may be driven by a suitable power source 104. The power source 104, disclosed herein, may include but is not limited to, engines, gas turbine engines, generator sets, and other types of power sources known to one commonly skilled in the art.

The pump 100 includes a suction manifold 106, a discharge manifold 108, and multiple cylinders 110 located between the suction manifold 106 and the discharge manifold 108 (only one cylinder 110 visible in the cross-sectional view of the pump 100 of FIG. 1).

The suction manifold 106 may be configured to receive a fracking fluid that is mixed at a blender (not shown). The cylinders 110 are provided with movable components therein, for e.g., reciprocating pistons 111, that is configured to pressurize the fracking fluid during operation. The discharge manifold 108 of the pump 100 is configured to output pressurized fracking fluid therefrom into a wellbore for fracturing deep-rock formations (not shown) located under the earth's surface (not shown).

As shown in FIG. 1, the pump 100 may be coupled with the system 102 of the present disclosure. The system 102 includes a first pressure sensor 112, a second pressure sensor 114, and multiple third pressure sensors 116. However, only one third pressure sensor 116 is shown to correspond with the cross-sectional view of pump 100 in the illustrated embodiment of FIG. 1.

The first pressure sensor 112 may be associated with the suction manifold 106 of the pump 100 and configured to output a pressure value associated with the suction manifold 106. The second pressure sensor 114 may be associated with the discharge manifold 108 of the pump 100 and configured to output a pressure value associated with the discharge manifold 108. Each of the third pressure sensors 116 may be associated with at least one cylinder 110 of the pump 100 so that each of the third pressure sensors 116 are configured to output a pressure value associated with a corresponding cylinder 110 of the pump 100.

With continued reference to FIG. 1, the system 102 further includes a historical dataset 120. In an embodiment, the historical dataset 120 may be implemented on a memory device 122, which will be explained in greater detail later herein. The historical dataset 120 includes a first set of flow rate pressure values (hereinafter simply referred to as “historical pressure values”) obtained from at least one pressure sensor i.e., in this case, the first pressure sensor 112, the second pressure sensor 114, and each of the third pressure sensors 116. The historical pressure values disclosed herein is obtained over a specified time period to determine an existing hydraulic signature of the pump 100.

The historical pressure values from the historical dataset 120 are representative of a historical performance of the pump 100. Moreover, in one embodiment, the historical pressure values in the historical dataset 120 may be obtained from the first, second, and third pressure sensors 112, 114, and 116 when the frag rig pump was operating under healthy and normal operating conditions. The terms “healthy and normal operating conditions” for the pump 100 may be regarded when components of the pump 100 have undergone no deterioration in performance and when the pump 100 is operating under standard load conditions.

As shown in FIG. 1, the system 102 further includes a data acquisition engine (DAE) 118. The DAE 118 is configured to obtain real-time flow rate pressure values (hereinafter simply referred to as “real-time pressure values” or “current pressure values”) from at least one pressure sensor, in this case, the first pressure sensor 112, the second pressure sensor 114, and each of the third pressure sensors 116. The real-time pressure values are measured during a current operating condition of the pump 100 to determine a current hydraulic signature of the pump 100. The terms “current operating condition” for the pump 100 may be regarded as an operating condition that is different from when the pump is operating in the healthy and normal operating conditions. For example, the “current operating conditions” may refer to an operating condition of the pump when components of the pump have undergone some deterioration, or when the pump is operating under load conditions different from that of standard load conditions. As such, the DAE 118 is in communication with the first, second, and third pressure sensors 112, 114, and 116 and may obtain on a real-time basis, the current pressure values that are associated with the suction manifold 106, the discharge manifold 108, and each cylinder 110 of the pump 100.

With continued reference to FIG. 1, the system 102 further includes a comparison engine 124 disposed in communication with the historical dataset 120 and the DAE 118. The comparison engine 124 is configured to detect variances in the hydraulic signatures i.e., current hydraulic signature and existing hydraulic signature based upon a comparison between the real-time pressure values and the historical pressure values. Upon detection of variances between the current hydraulic signature and the existing hydraulic signature, the comparison engine 124 is configured to selectively output a mode of failure for the pump 100. Additionally, the comparison engine 124 may be further configured to determine service life before failure of the pump 100. The comparison engine 124 may be configured with suitable algorithms, programs, and/or routines that may be employed to determine the service life of the pump 100 before failure.

As shown in FIG. 1, the system 102 further includes a display device 128 disposed in communication with the comparison engine 124. The display device 128 is configured to display the mode of failure, and the service life remaining before failure of the pump 100 that is output from the comparison engine 124. Explanation to the display device 128 will be made in greater detail later herein.

The system 102 may further include a controller 126 disposed in communication with the comparison engine 124 and the display device 128. The controller 126 is configured to determine a location of a leak as being in at least one of a suction valve 130 associated with the suction manifold 106, a discharge valve 132 associated with the discharge manifold 108, and packing 134 associated with one or more cylinders 110 of the pump 100. Additionally, the controller 126 may also be configured to modulate an operation of the pump 100 based on the comparison between the real-time pressure values and the historical pressure values. For example, based on the comparison between the real-time pressure values and the historical pressure values, the controller 126 may modulate i.e., increase or decrease, a speed of the pump 100.

The controller 126 disclosed herein may embody a single microprocessor or multiple microprocessors that include components for controlling operations of the pump 100 based on inputs from the comparison engine 124 and/or inputs from an operator and based on sensed or other known operational parameters. Numerous commercially available microprocessors can be configured to perform the functions of the controller 126 disclosed herein. It should be appreciated that the controller 126 could readily be embodied in a general machine microprocessor capable of controlling numerous machine functions. The controller 126 may include a memory, a secondary storage device, a processor, and any other components for running an application. Various other circuits may be associated with the controller 126 such as power supply circuitry, signal conditioning circuitry, solenoid driver circuitry, and other types of circuitry. Various routines, algorithms, and/or programs can be programmed within the controller 126 for execution thereof to modulate an operation of the pump 100 based on the comparison between the real-time pressure values with the historical pressure values obtained from the historical dataset 120.

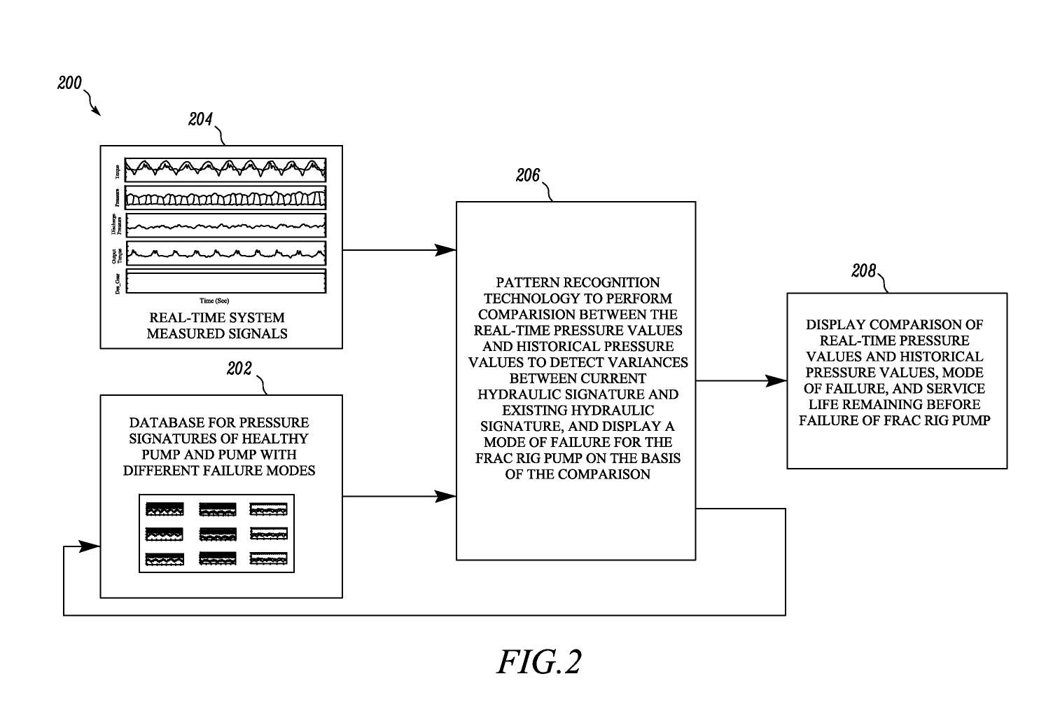

Referring now to FIG. 2, an exemplary process 200 pursuant to embodiments of the present disclosure is outlined. It may be noted that the process 200 illustrated in FIG. 2 is rendered to merely aid the reader's understanding of the present disclosure and hence, is not to be construed as limiting of the present disclosure.

Referring to the illustrated embodiment of FIG. 2, the process 200 includes function blocks 202 through 208. The order or sequence of the function blocks 202-208 is merely exemplary in nature and hence, non-limiting of this disclosure. It may be noted that the order or sequence of the function blocks may be re-ordered or re-arranged without deviating from the spirit of the present disclosure.

At function block 202, historical pressure values pertaining to the pump 100 may be available vis-à-vis the historical dataset 120 (See FIG. 1). Moreover, at function block 204, real-time pressure values may be available from the first, second, and third pressure sensors 112, 114, and 116 (Refer to FIG. 1). As shown in function block 206 of FIG. 2, the real-time pressure values may be compared with the historical pressure values to detect variances between the current hydraulic signature and the existing hydraulic signature of the pump 100 and output a mode of failure based on the comparison. In determining the mode of failure, a location of leak in the pump 100 may be associated with at least one of the suction valve 130, the discharge valve 132, and the packing 134 associated with each cylinder 110 of the pump 100 (Refer to FIG. 1).

Upon comparison at the function block 208, the process 200 proceeds to function block 210, where a mode of failure may be displayed via the display device 128 (Refer to FIG. 1). In addition to the mode of failure, a comparison of the real-time pressure values to the historical pressure values, and service life remaining before failure of the pump may be displayed together with the mode of failure for the pump 100. In an embodiment, the comparison of the real-time pressure values to the historical pressure values, the mode of failure, and the service life remaining before failure of the pump 100 may altogether be displayed on the display device 128 itself.

Alternatively, indicators (not shown) may be used to indicate the status or health of components in the pump 100. For example, three indicators may be used for distinctly indicating failed, warning (for future failure), and healthy status of components in the pump 100. These indicators may be implemented in the form of a visual based indication device (not shown), such as, but not limited to, light emitting diodes (LED). Although a visual based indication device has been disclosed herein, one of ordinary skill in the art may contemplate other devices for producing indications. For example, audio based indication's may be used in lieu of the visual based indication device disclosed herein. Therefore, it is to be noted that a type or nature of the indication device is merely exemplary in nature and non-limiting of this disclosure. Any type or nature of indication device may be employed by the system 102 of the present disclosure to render an indication of the status or health of components in the pump 100.

Further, it may be noted that upon comparison at the function block 208, the process 200 also continues into function block 202 to update the memory device 122 (Refer to FIG. 1) with the current hydraulic signatures. This way, the current hydraulic signatures at a given point of time may be used as the existing hydraulic signatures at a subsequent period of time.

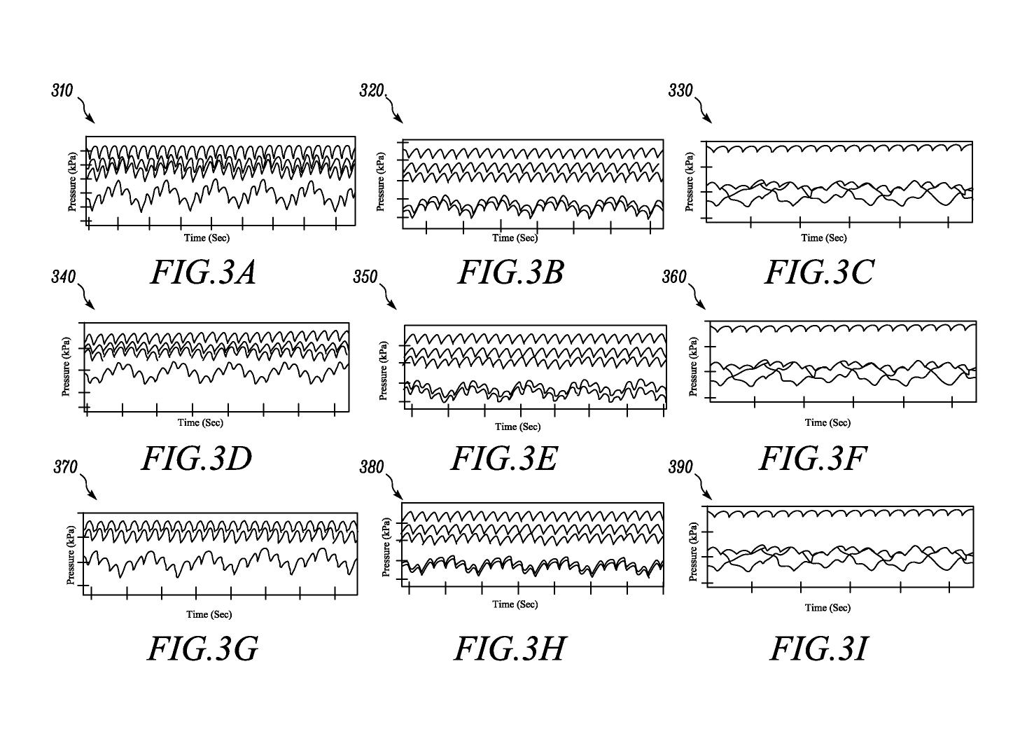

FIGS. 3A to 3I are exemplary plots representative of modes of failure for the pump 100 that are identified upon comparison of a current hydraulic signature with an existing hydraulic signature of the pump 100. As such, the controller 126 of the present disclosure is configured to analyze flow rate pressure values from the first pressure sensor 112, the second pressure sensor 114, and the third pressure sensors 116 in a pressure-time domain.

Referring to FIG. 3A, the plot 310 is representative of a leakage that may arise from a failure in the packing 134 associated with the 1^{st} cylinder 110 of the pump 100. Referring to FIG. 3B, the plot 320 is representative of a leakage that may arise from a failure in the packing 134 associated with the 1^{st} and 3^{rd} cylinder 110 of the pump 100. Referring to FIG. 3C, the plot 330 is representative of a leakage that may arise from a failure in the packing 134 associated with the 1^{st} and 3^{rd} cylinder 110 of the pump 100. However, the amplitudes of leakage in the respective packings 134 of the 1^{st} and 3^{rd} cylinders 110 are different. As such, this difference in the amplitude of leakages in the packings 134 of the 1^{st} and 3^{rd} cylinders 110 may be evident from the difference in pattern of the pressure signatures from plots 320 and 330.

Referring to FIG. 3D, the plot 340 is representative of a leakage that may arise from a failure in the suction valve 130 associated with the 1^{st} cylinder 110 of the pump 100. Referring to FIG. 3E, the plot 350 is representative of a leakage that may arise from a failure in the suction valves 130 associated with the 1^{st} and 3^{rd} cylinder 110 of the pump 100. Referring to FIG. 3F, the plot 360 is representative of a leakage that may arise from a failure in the suction valves 130 associated with the 1^{st} and 3^{rd} cylinder 110 of the pump 100. However, the amplitude of leakage in the suction valves 130 of the 1^{st} and 3^{rd} cylinders 110 of the pump 100 is different. As such, this difference in the amplitude of leakages in the suction valves 130 of the 1^{st} and 3^{rd} cylinders 110 may be evident from the difference in pattern of the pressure signatures from plots 350 and 360.

Referring to FIG. 3G, the plot 370 is representative of a leakage that may arise from a failure in the discharge valve 132 associated with the 1^{st} cylinder 110 of the pump 100. Referring to FIG. 3H, the plot 380 is representative of a leakage that may arise from a failure in the discharge valves 132 associated with the 1^{st} and 3^{rd} cylinder 110 of the pump 100. Referring to FIG. 3I, the plot 390 is representative of a leakage that may arise from a failure in the discharge valves 132 associated with the 1st and 3rd cylinder 110 of the pump 100. However, the amplitude of leakage in the discharge valves 132 of the 1^{st} cylinder 110 and the 3^{rd} cylinder 110 of the pump 100 are different. As such, this difference in the amplitude of leakages in the discharge valves 132 of the 1^{st} and 3^{rd} cylinders 110 may be evident from the difference in pattern of the pressure signatures from plots 380 and 390.

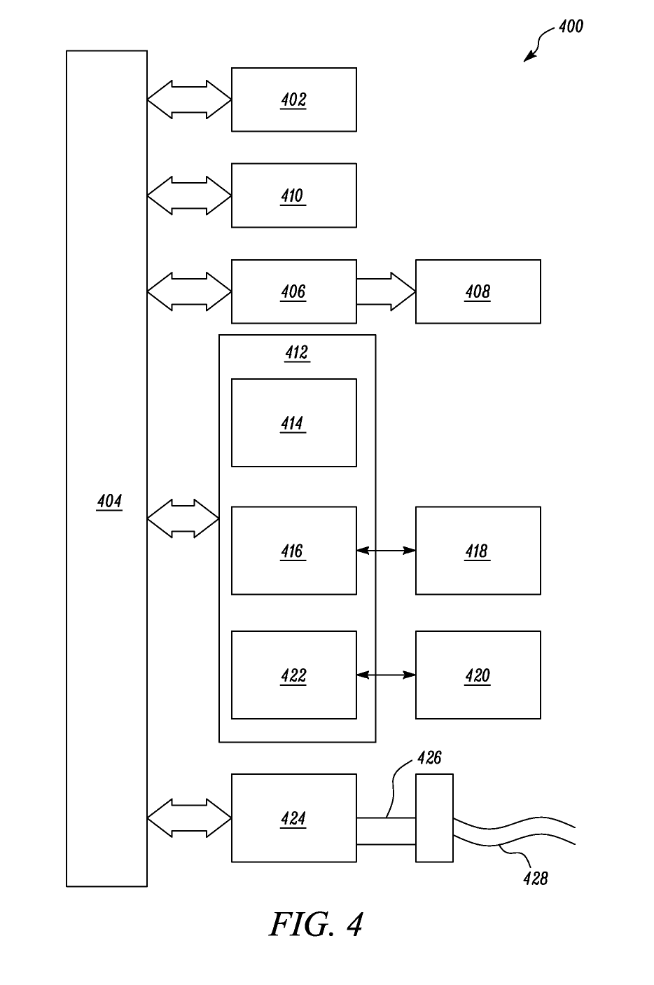

In accordance with an embodiment of the present disclosure, the present disclosure is directed towards one or more computer systems capable of carrying out the functionality described herein. An example of the computer based system includes a computer system 400, which is shown by way of a block diagram in FIG. 4.

Computer system 400 includes at least one processor, such as a processor 402. Processor 402 may be connected to a communication infrastructure 404, for example, a communications bus, a cross-over bar, a network, and the like. Various software embodiments are described in terms of this exemplary computer system 400. Upon perusal of the present description, it will become apparent to a person skilled in the relevant art(s) how to implement the present disclosure using other computer systems and/or architectures.

Computer system 400 includes a display interface 406 that forwards graphics, text, and other data from communication infrastructure 404 (or from a frame buffer) for display on a display unit 408.

Computer system 400 further includes a main memory 410, such as random access memory (RAM), and may also include a secondary memory 412. Secondary memory 412 may further include, for example, a hard disk drive 314 and/or a removable storage drive 416, representing a floppy disk drive, a magnetic tape drive, an optical disk drive, etc. Removable storage drive 416 reads from and/or writes to a removable storage unit 418 in a well-known manner. Removable storage unit 418 may represent a floppy disk, magnetic tape or an optical disk, and may be read by and written to by removable storage drive 416. As will be appreciated, removable storage unit 418 includes a computer usable storage medium having stored therein, computer software and/or data.

In accordance with various embodiments of the present disclosure, secondary memory 412 may include other similar devices for allowing computer programs or other instructions to be loaded into computer system 400. Such devices may include, for example, a removable storage unit 420, and an interface 422. Examples of such may include a program cartridge and cartridge interface (such as that found in video game devices), a removable memory chip (such as an erasable programmable read only memory (EPROM), or programmable read only memory (PROM)) and associated socket, and other removable storage units 420 and interfaces 422, which allow software and data to be transferred from removable storage unit 420 to computer system 400.

Computer system 400 may further include a communication interface 424. Communication interface 424 allows software and data to be transferred between computer system 400 and external devices. Examples of communication interface 424 include, but may not be limited to a modem, a network interface (such as an Ethernet card), a communications port, a Personal Computer Memory Card International Association (PCMCIA) slot and card, and the like. Software and data transferred via communication interface 424 may be in the form of a plurality of signals, hereinafter referred to as signals 426, which may be electronic, electromagnetic, optical or other signals capable of being received by communication interface 424. Signals 426 may be provided to communication interface 424 via a communication path (e.g., channel) 428. Communication path 428 carries signals 426 and may be implemented using wire or cable, fiber optics, a telephone line, a cellular link, a radio frequency (RF) link and other communication channels.

In this document, the terms “storage medium” is used to generally refer to media such as removable storage drive 416, a hard disk installed in hard disk drive 314, signals 426, and the like. These computer program products provide software to computer system 400. The present disclosure is hereby also directed to such computer program products.

Computer programs (also referred to as computer control logic) may be stored in the main memory 410 and/or the secondary memory 412. Computer programs may also be received via the communication interface 304. Such computer programs, when executed, enable computer system 400 to perform the functions consistent with the present disclosure, as discussed herein. In particular, the computer programs, when executed, enable processor 402 to perform the features of the present disclosure.

In accordance with an embodiment of the present disclosure, where the disclosure is implemented using a software, the software may be stored in a computer program product and loaded into computer system 400 using removable storage drive 416, hard disk drive 314 or communication interface 424. The control logic (software), when executed by processor 402, causes processor 402 to perform the functions of the present disclosure as described herein.

In another embodiment, the present disclosure is implemented primarily in hardware using, for example, hardware components such as application specific integrated circuits (ASIC). Implementation of the hardware state machine so as to perform the functions described herein will be apparent to persons skilled in the relevant art(s).

Various embodiments disclosed herein are to be taken in the illustrative and explanatory sense, and should in no way be construed as limiting of the present disclosure. All joinder references e.g., attached, affixed, coupled, engaged, connected, and the like are only used to aid the reader's understanding of the present disclosure, and may not create limitations, particularly as to the position, orientation, or use of the systems, processes, and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

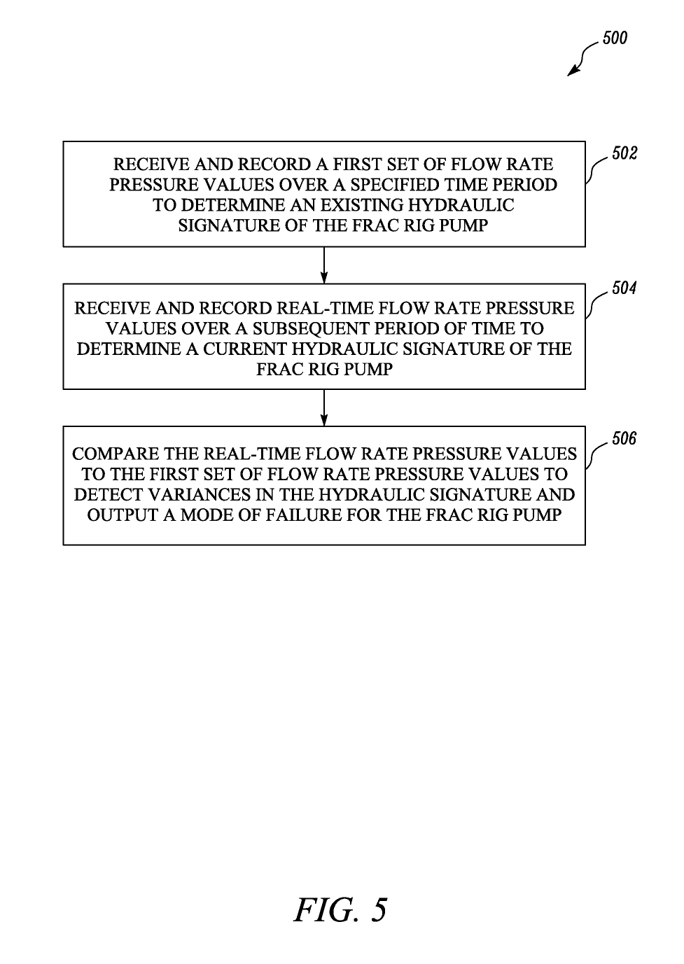

FIG. 5 illustrates a method 500 for identifying a mode of failure in the pump 100. At step 502, the method 500 includes receiving and recording the first set of flow rate pressure values (i.e., historical pressure values) over a specified time period to determine an existing hydraulic signature of the pump 100. As disclosed earlier herein, the first set of flow rate pressure values are obtained from at least one pressure sensor, i.e., the first pressure sensor 112, the second pressure sensor 114, and the third pressure sensors 116 associated with the suction manifold 106, the discharge manifold 108, and each cylinder 110 of the pump 100 respectively.

At step 504, the method 500 includes receiving and recording real-time flow rate pressure values (i.e., real-time pressure values) over a subsequent period of time to determine the current hydraulic signature of the pump 100. As with the historical pressure values, the real-time pressure values are also obtained from the first pressure sensor 112, the second pressure sensor 114, and the third pressure sensors 116 associated with the suction manifold 106, the discharge manifold 108, and each cylinder 110 of the pump 100 respectively.

At step 506, the method 500 further includes comparing the real-time flow rate pressure values to the first set of flow rate pressure values to detect variances in the hydraulic signature and output a mode of failure for the pump 100. Upon receipt of the real-time pressure values, the comparison engine 124 is configured to compare the real-time flow rate pressure values to the first set of flow rate pressure values to detect variances in the hydraulic signature and output a mode of failure for the pump 100.

In methodologies directly or indirectly set forth herein, various steps and operations are described in one possible order of operation, but those skilled in the art will recognize that steps and operations may be re-arranged, replaced, or eliminated without departing from the spirit and scope of the present disclosure as set forth in the claims.

Embodiments of the present disclosure have applicability for use and implementation in identifying a mode of failure in a pump. Typically, components of a pump are subject to high working pressures during operation of the pump. Consequently, a frequency of failure and subsequent maintenance of the components in a given pump may be high.

With implementation of the system 102 disclosed herein, operators of pumps may be provided with an indication regarding the type of failure and its location. With indication of a failure, operators of a given pump may conveniently plan to perform shutdown, replacement, maintenance, overhaul, and/or other service routines on the pump in a timely manner with little or no obstruction to an ongoing procedure in a jobsite, i.e., a wellbore. Moreover, upon detection of a failure by the system 102, operators may conveniently perform the necessary actions as the system 102 is configured to locate the leak and display such location of the leakage/s to an operator of the pump. Therefore, with use of the system 102 disclosed herein, time and effort previously incurred with maintenance of pumps may be offset thus saving costs to operators of pumps.

While aspects of the present disclosure have been particularly shown and described with reference to the embodiments above, it will be understood by those skilled in the art that various additional embodiments may be contemplated by the modification of the disclosed machines, systems, processes, and methods without departing from the spirit and scope of what is disclosed. Such embodiments should be understood to fall within the scope of the present disclosure as determined based upon the claims and any equivalents thereof.

What is claimed is:

1. A method for identifying a mode of failure in a pump, the method comprising:
receiving and recording a first set of flow rate pressure values over a specified time period to determine an existing hydraulic signature of the pump;
receiving and recording real-time flow rate pressure values over a subsequent period of time to determine a current hydraulic signature of the pump; and
comparing the real-time flow rate pressure values to the first set of flow rate pressure values to detect variances in the hydraulic signature and output a mode of failure for the pump.

2. The method of claim 1, wherein the first set of flow rate pressure values is obtained from a pressure sensor associated with one of a suction manifold, a discharge manifold, and a cylinder of the pump.

3. The method of claim 1, wherein the first set of flow rate pressure values over the specified time period is representative of historical performance of the pump.

4. The method of claim 1, wherein the real-time flow rate pressure values over the subsequent period of time is representative of current performance of the pump.

5. The method of claim 1, wherein the first set of flow rate pressure values and the real-time flow rate pressure values are recorded in a memory device.

6. The method of claim 1 further comprising determining a service life of the pump before failure.

7. The method of claim 1 further comprising displaying the mode of failure for the pump, and a service life remaining before failure of the pump on a display device.

8. The method of claim 1 further comprising modulating an operation of the pump based on the comparison between the real-time flow rate pressure values and the first set of flow rate pressure values associated with the pump.

9. The method of claim 1 further comprising comparing the current hydraulic signature of the pump to a historical hydraulic signature of the pump to detect variances in the hydraulic signature and output a mode of failure for the pump.

10. A system for identifying a mode of failure in a pump, the system comprising:
at least one pressure sensor associated with at least one of a suction manifold, a discharge manifold, and a cylinder of the pump to output pressure values associated with the at least one of the suction manifold, the discharge manifold, and the cylinder of the pump;
a historical dataset comprising a first set of flow rate pressure values obtained from the at least one pressure sensor, the first set of flow rate pressure values obtained over a specified time period to determine an existing hydraulic signature of the pump;
a data acquisition engine configured to obtain real-time flow rate pressure values from the at least one pressure sensor, the real-time flow rate pressure values measured during a current operating condition of the pump to determine a current hydraulic signature of the pump; and
a comparison engine in communication with the historical dataset, and the data acquisition system, the comparison engine configured to compare the real-time flow rate pressure values to the first set of flow rate pressure values to detect variances in the hydraulic signatures and output a mode of failure for the pump.

11. The system of claim 10, wherein the at least one pressure sensor comprises:
a first pressure sensor located in the suction manifold of the pump and configured to output a flow rate pressure value associated with the suction manifold;
a second pressure sensor located in the discharge manifold of the pump and configured to output a flow rate pressure value associated with the discharge manifold;
a plurality of third pressure sensors, wherein at least one third pressure sensor is located in each cylinder of the pump such that the third pressure sensors are configured to output a flow rate pressure value associated with the cylinders of the pump.

12. The system of claim 10 further comprising a controller disposed in communication with the comparison engine, the controller configured to determine a location of a leak as being in at least one of a suction valve associated with the suction manifold, a discharge valve associated with the discharge manifold, and packing associated with one or more cylinders of the pump.

13. The system of claim 12, wherein the controller is configured to modulate the operation of the pump based on the comparison between the real-time flow rate pressure values and the first set of flow rate pressure values.

14. The system of claim 10, wherein the comparison engine is configured to determine a service life of the pump before failure.

15. The system of claim 10, further comprising a memory device in communication with the comparison engine, the memory device configured to store the first set of flow rate pressure values and the real-time flow rate pressure values therein.

16. The system of claim 10 further comprising a display device disposed in communication with the comparison engine, the display device configured to display the comparison between the existing hydraulic signature and the current hydraulic signature of the pump.

17. The system of claim 10, wherein the controller is configured to analyze flow rate pressure values from the first pressure sensor, the second pressure sensor, and the third pressure sensors in a time-frequency domain.

18. A non-transitory computer-readable medium having stored thereon sequences of instruction, the sequences of instruction including instruction which when executed by a computer-based system for identifying a mode of failure in a pump, causes the computer-based system to perform operations, comprising:
receiving and recording, by the computer based system, a first set of flow rate pressure values over a specified time period to determine an existing hydraulic signature of the pump;
receiving and recording, by the computer based system, real-time flow rate pressure values over a subsequent period of time to determine a current hydraulic signature of the pump; and
comparing, by the computer based system, the real-time flow rate pressure values to the first set of flow rate pressure values to detect variances in the hydraulic signature and output a mode of failure for the pump.
